(19) United States
(12) Patent Application Publication
(10) Pub. No.: US 2011/0223389 A1
(43) Pub. Date: Sep. 15, 2011

(54) DECORATIVE FILM, METHOD FOR MANUFACTURING THEREOF, AND DECORATIVE MOLDING ARTICLE

(76) Inventors: Chun-Hsu LIN, Taichung City (TW); Chao-Peng Tseng, Jhongli City (TW)

(21) Appl. No.: 12/721,140

(22) Filed: Mar. 10, 2010

(51) Int. Cl. B32B 1/00; B32B 7/02; B32B 3/10; B32B 33/00; B05D 1/36; B05D 3/00; B05D 5/00; B05D 5/10

(52) U.S. Cl. 428/174; 428/212; 428/195.1; 428/201; 427/402; 427/331; 427/258; 427/207.1

(57) ABSTRACT

The present invention provides a decorative film, a method for manufacturing thereof, and a decorative molding article. The decorative film includes a carrier layer, a release layer and a compound-material layer. The compound-material layer is compounded of at least two materials with different refractive index, thus the decorative film has a mat visible result of low glossy. The compound-material layer could be partially formed on the decorative film by using a shielding layer and an etching process. Thus, it has a visible result of glossy-bright-glossy. An ink layer with the manufacturing time could be omitted and cost is saved.

### BACKGROUND OF THE INVENTION

1. Field of the Invention

The present invention relates to a decorative film, method for manufacturing thereof, and decorative molding article, in particular, to a decorative film has a visible result of low glossy.

2. Description of Related Art

In-mold decoration (IMD) is an art through injection molding for transferring a plastic film with an ink pattern to a part. The plastic film for in-mold decoration usually is composed of a carrier layer, a release layer, a durable layer, an ink layer and an adhered layer in order. After plastic injection, a plastic is injected to the adhered layer, and the release layer which contacted with the durable layer is released by an ejection process. Therefore, the carrier layer together with the release layer are separated from the durable layer. Finally, all of ink patterns on the ink layer and the durable layer are remained on the part.

By the conventional in-mold decoration process, the part is printed with the ink layer and the durable layer by transfer printing. The durable layer becomes the outmost layer of the part after transfer printing, and has a glossy and smooth surface. Such surface makes the part having a certain of gloss, which is easily to get fingerprint after touched by people's finger. The lipid composition on finger is easily to attached on the glossy durable layer and became fingerprints. However, some part is required to appear an appearance of mat (low glossy) on the surface, the film of conventional in-mold decoration may not satisfy it.

In order to solve the requirements of fingerprint-resistant and low glossy surface, one method is to produce a low glossy result on the surface of the durable layer, and develops a decorative film with matting effect. In which, particles were added into the durable layer, thus the light is scattered by the particles and a mat surface is formed on its surface. However, the durable layer needs to have a certain thickness, and the size of added particles must be larger than the thickness of the durable layer. Consequently, the particles that have a size too large are easily descended and deposited, which results in an uneven distribution of the particles in the continuous process.

Another method is used to solve the requirements of fingerprint-resistant and low glossy surface, which added particles into the release layer. However, the release layer has an ingredient of silicone, which has a worse compatibility with the particles themselves. The dried decorative film usually accompanied with phase separation. The organic phase is separated from the inorganic phase, and the particles were distributed unevenly.

There is still a conventional method, which added particles into the carrier layer ahead. After the followed release layer is covered, the surface of the release layer also is equipped with a feeling of mat. But this kind of carrier layer is belonged to such special purpose, it's hard to mass produce. The total cost of manufacture is increased.

### SUMMARY OF THE INVENTION

In view of the aforementioned issues, the present invention provides a decorative film, method for manufacturing thereof, and decorative molding article. The decorative film not only has a low glossy feeling, but also has a luxurious metallic design similar to the color tone of a metal plating.

To achieve the above-mentioned objectives, the present invention provides a decorative film, which includes a carrier layer, a release layer and a compound-material layer. The release layer is formed on the carrier layer. The compound-material layer is contiguous to the release layer, and is compounded of at least two materials with different refractive index. After the carrier layer is separated from the release layer, a gloss on the surface of the decorative film can be reduced by the compound-material layer.

To achieve the above-mentioned objectives, the present invention provides a method for manufacturing a decorative film including steps as follows. A carrier layer is provided. A release layer is formed on the carrier layer. A compound-material layer is deposited contiguous to the release layer, in which the compound-material layer is compounded of at least two materials with different refractive index. After the carrier layer is separated from the release layer, a gloss on the surface of the decorative film can be reduced by the compound-material layer.

To achieve the above-mentioned objectives, the present invention provides a decorative molding article including the decorative film as described above, and a plastic piece is formed on the compound-material decorative layer.

The present invention applies the compound-material layer, which can be formed on the durable layer or the release layer by evaporation, sputtering. Through the different refractive indexes in the compound-material layer, brightness and resolution of the reflected image of an ambient light source can be inhibited or suppressed. Thus, the present invention produces a visible mat effect (low glossy) on the surface of the decorative film and the decorative molding article equipped with the decorative film.

In order to further understand the techniques, means and effects the present invention takes for achieving the prescribed objectives, the following detailed descriptions and appended drawings are hereby referred, such that, through which, the purposes, features and aspects of the present invention can be thoroughly and concretely appreciated; however, the appended drawings are merely provided for reference and illustration, without any intention to be used for limiting the present invention.

### BRIEF DESCRIPTION OF THE DRAWINGS

FIG. 1 is a cross-sectional view of a decorative film according to the present invention;

FIG. 2 is a cross-sectional view of a decorative film of second embodiment according to the present invention;

FIG. 3 is a cross-sectional view of a decorative film with a die according to the present invention;

FIG. 4 is a cross-sectional view of a decorative molding article with a decorative film of third embodiment according to the present invention;

FIG. 5 is a cross-sectional view of a decorative film of fourth embodiment according to the present invention;

FIG. 6 is a cross-sectional view of a decorative film of fifth embodiment according to the present invention; and

FIG. 7 is a top view of the decorative molding article of third embodiment according to the present invention.

### DETAILED DESCRIPTION OF THE PREFERRED EMBODIMENTS

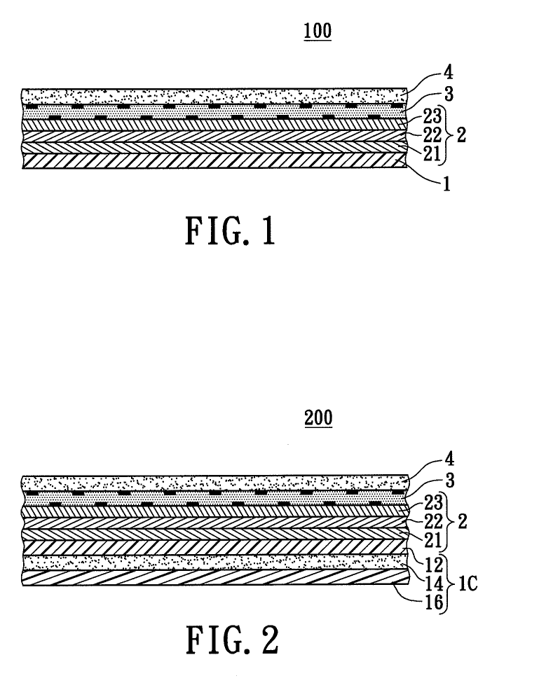

Reference is made to FIG. 1, which is a cross-sectional view of a decorative film according to the present invention. A decorative film 100 of in-mold decoration (IMD) according to the present invention includes a base substrate 1, a compound-material layer 2, an ink layer 3 and an adhesive layer 4. In this present invention, the compound-material layer 2 can be formed with patterns, so the ink layer 3 is optional.

Concerning the base substrate 1, it would has at least two embodiments according to different IMD processes. First, please refer to FIG. 1. For an in-mold decoration process, the base substrate 1 could be one Polycarbonate (PC), Polyethylene terephthalate (PET), polyethylene terephthalate, polyethylene naphthalate, glycol-polyethylene terephathalate, thermoplastic polyurethane, polyurethane, polypropylene, polycarbonate, amorphous polyethylene terephthalate, polyvinyl chloride, cellulose triacetate, polyamide, styrene-methyl methacrylate copolymer, or cyclic olefin copolymer, or a combination of the aforementioned materials. The base substrate 1 is remained after injection and is treated as an outmost surface. To apply the in-mold decoration process in this present invention, it would be composed of steps as follows. The base substrate 1 is provided, and the compound-material layer 2 is formed on the base substrate 1. If some specific complex figure is required, it can be performed by printing the ink layer 3 to show patterns on the compound-material layer 2. Then, the adhesive layer 4 is applied on the ink layer 3. The adhesive layer 4 can be made from hot melt adhesive, UV curable adhesive, photo curable adhesive, or electron curable adhesive, which is designed to make the decorative film 100 adhere to molded resin in injection process. In this in-mold decoration process, the pattern, which is formed by the compound-material layer 2 or the ink layer 3, is placed between the base substrate 1 and the molded plastic material and could be protected well.

Another embodiment is illustrated in FIG. 2, which shows a cross-sectional view of a decorative film of second embodiment according to the present invention. A decorative film 200 includes a base substrate 1C, the compound-material layer 2, the ink layer 3, and the adhesive layer 4. For an in-mold roller (IMR) process, the base substrate 1C includes an optional durable layer 12, a release layer 14, and a carrier layer 16. The carrier layer 16 may be made of substantially the same material of the base substrate 1 as mentioned in respect of the embodiment shown in FIG. 1. The release layer 14 is formed on the carrier layer 16 for releasing the carrier layer 16 after molded plastic material is injected. In this embodiment, the release layer 14 can be formed from wax, paraffin or silicone or a highly smooth and impermeable coating prepared from a radiation curable multifunctional acrylate, silicone acrylate, epoxide, vinyl ester, vinyl ether, allyl or vinyl, unsaturated polyester or a blend thereof. The durable layer 12 is placed on the release layer 14 to protect the pattern, which is formed by the compound-material layer 2 or the ink layer 3. The durable layer 12 also can be formed on the compound-material layer 2, and is disposed between the ink layer 3 and the compound-material layer 2. The decorative film 200 could be rolled as a roller type. The materials applied in the durable layer 12 include a radiation-cured multi-functional group acrylic ester, epoxide, a vinyl ester resin, diallyo(o-)phthalate, vinyl ether, or the combination of the abovementioned materials. The radiation-cured multi-functional group acrylic ester may be epoxy acrylate, polyurethane acrylate, polyester acrylate, silicone acrylate, or glycidyl acrylate.

Reference is made to FIGS. 1 to 2. The compound-material layer 2 of the present invention is compounded of at least two materials with different refractive index. Through the compound-material layer 2 with multi-layers of different refractive index, the decorative film has a visible effect of low gloss. It can use alternating layers of a low-index material 22 and a higher-index material 21 or 23. For example, TiO₂ of high refractive index cooperates with SiO₂ or Al₂O₃ of low refractive index, which are formed on the base substrate 1 or the durable layer 12 of transparent material. Through the function of optical grating, the light reflected by TiO₂ of high refractive index is destructively interfered with the light reflected by SiO₂ of low refractive index. For double-layered structure, the compound-material layer 2 could be TiO₂/Al₂O₃ double-layered structure or TiO₂/SiO₂ double-layered structure formed in a stacked way.

The compound-material layer 2 can be formed with plural metallic layers by an evaporation method or a sputtering method. Evaporative deposition is a physical vapor deposition (PVD) method, in which the material to be deposited is heated to a high vapor pressure by electrically resistive heating in “low” vacuum. Evaporation method is a method used to process thin film deposition. The source material is evaporated in a vacuum. The vacuum allows vapor particles to travel directly to the target object (substrate), where they condense back to a solid state. Evaporation is used in microfabrication, and to make macro-scale products such as metallized plastic film. Sputter deposition is a physical vapor deposition (PVD) method of depositing thin films by sputtering, that is ejecting, material from a “target,” that is source, which then deposits onto a “substrate”. In which a glow plasma discharge (usually localized around the “target” by a magnet) bombards the material sputtering some away as a vapor. After the carrier layer 16 is released with the release layer 14, a gloss on the surface of the decorative film 200 is reduced by the compound-material layer 2. Furthermore, the decorative film 200 will has a luxurious metallic design similar to the color tone of a metal plating.

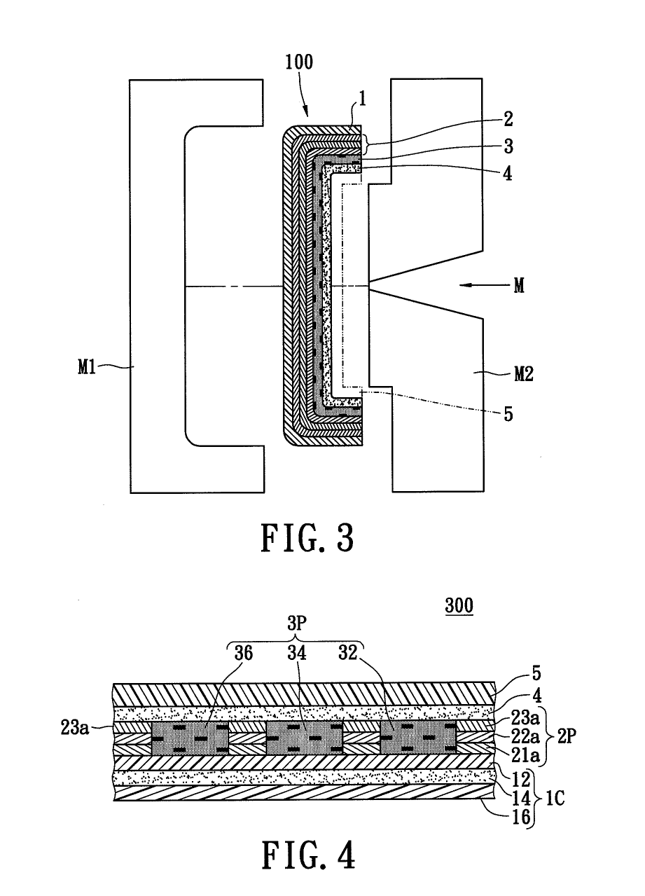

Reference is made to FIG. 3, which is a cross-sectional view of a decorative film with a die according to the present invention. The decorative film 100 is disposed between a pair of dies M1 and M2. A melted plastic M is injected to adhere to the adhesive layer 4 to form a decorative molding article according to the present invention. The decorative film 100 can be combined with a plastic piece 5 by in-mold roller process. The decorative film 100 of the present invention also can use other methods to combine with the plastic piece, such as injection molding method, thermoforming molding method, compression molding method, blow molding method, heat transfer method, hot stamping method, laminating method, in-mold method, or extrusion molding method, or an assembled method thereof. The plastic piece 5 can use the material of Polycarbonate (PC), polypropylene (PP), Polymethyl methacrylate (PMMA), Styrene-methyl methacrylate copolymer (MS), Acrylonitrile butadiene styrene (ABS), Polystyrene (PS), Polyethylene terephthalate (PET), Polyoxymethylene (POM) Nylon or the combinations thereof.

Reference is made to FIG. 4, which is a cross-sectional view of a decorative molding article with a decorative film of third embodiment according to the present invention. In the second embodiment presented above, the compound-material layer 2 is covered fully on the durable layer 12. In this third embodiment, a decorative molding article 300 is characteristic with a compound-material layer 2P which is partially covered on the durable layer 12. A method for manufacturing the decorative molding article 300 according to the present invention includes the steps as follows. First, the carrier layer 16 is provided. The release layer 14 is formed on the carrier layer 16. The durable layer 12 is formed on the release layer 14. Second, the compound-material layer 2P is deposited partially contiguous to the durable layer 12, wherein the compound-material layer 2P is compounded of at least two materials 21a, 22a, 23a with different refractive index. In detail, the process of patterning the compound-material layer 2P includes steps as followed. A shielding layer (not shown) is formed on a part of the durable layer 12. The shielding layer can be formed by printing or coating. The areas of the shielding layer are 32, 34, and 36 as shown in FIG. 4. Then, the compound-material layer 2P is deposited on the durable layer 12 and the shielding layer. Next, the shielding layer is stripped to form a plurality of trenches which is exposed a portion of the durable layer 12 and side walls of the compound-material layer 2P. In this embodiment, the shielding layer may be made of polyurethane, polymethylmethacrylate, epoxide, polyester or a combination thereof. Finally, an ink layer 3P is printed on the trenches, which is partially spread on the durable layer 12 as 32, 34, and 36. As shown in FIG. 4, the adhesive layer 4 and the plastic piece 5 are formed continuously on the decorative molding article 300.

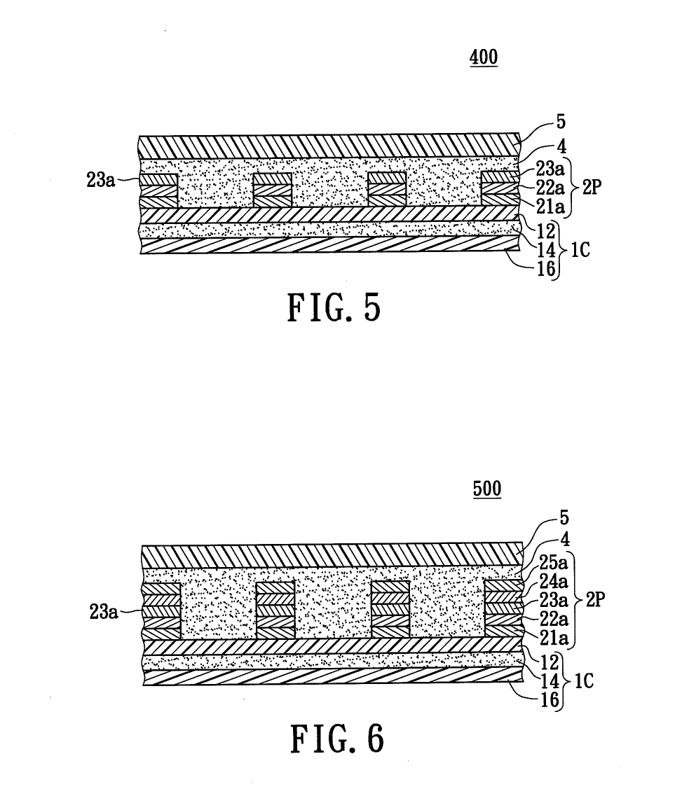

Reference is made to FIG. 5, which shows a cross-sectional view of a decorative molding article of fourth embodiment according to the present invention. In this embodiment, after the shielding layer is stripped, the adhesive layer 4 is directly printed or coated on the trenches and the compound-material layer 2P. After in-mold decoration (IMD) process is applied, a decorative molding article 400 is formed. The decorative molding article 400 has a special appearance effect that some portions with lower surface gloss, but some portions with higher surface gloss. The portions with lower surface gloss are in correspondence with the transparent compound-material layer 2P. The portions with higher surface gloss are in correspondence with the adhesive layer 4 between the compound-material layer 2P.

Reference is made to FIG. 6, which shows a cross-sectional view of a decorative molding article of fifth embodiment according to the present invention. In this embodiment, the compound-material layer 2P is deposited partially contiguous to the durable layer 12, wherein the compound-material layer 2P is compounded of five layers 21a, 22a, 23a, 24a and 25a with different refractive index. In detail, a metal layer 24a, such as Al, Ti, W, Cr, Au, Pt, Zn, Ag, Ni, Ge, In or Sn is deposited on the layer 23a, and an optional metal nitride layer 25a, such as AN, TiN, CrN, TiAlN, is deposited on the layer 24a. The layer 24a or 25a can express a luxurious metallic design similar to the color tone of a metal plating. After in-mold decoration (IMD) process is applied, a decorative molding article 500 is formed which has a lower gloss surface with metallic pattern. The advantage of this embodiment can omit the conventional ink layer.

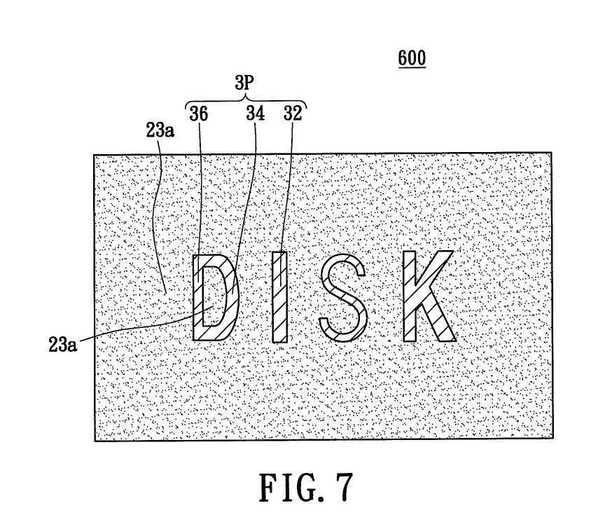

Reference is made to FIG. 7, which is a top view of the decorative molding article of third to fifth embodiment according to the present invention. In this embodiment, the compound-material layer 2P is patterned by partial deposited, thus it has a visible result of glossy-bright-glossy on the surface of the durable layer 12. For example, the pattern 3P in this decorative molding article 600 is “DISK”. The “DISK” could be formed by the ink layer 3P as shown in FIG. 4 with partial ink 32, 34 and 36, and it has a high glossy feeling. The other area of the decorative molding article 600 is partially covered by the compound-material layer 2P and it has a low glossy feeling. Moreover, the pattern 3P in this embodiment also could be formed by the adhesive layer 4 without any ink as shown in FIGS. 5 and 6, and the other area is partially covered by the compound-material layer 2P. Thus, it also has a visible result of alternate glossy-bright-glossy appearance.

The decorative molding article of the present invention can be used widely. The decorative molding component could be shaped in a shell for a mobile phone, digital camera, personal digital assistant (PDA), notebook PC, desktop PC, touch panel, television, GPS (globe position system) device, car monitor, navigation display, digital photo frame, DVD player, cosmetics products, toys, car dashboard, clock, radio, watch, credit card or smart card.

In summary, the present invention applies the compound-material layer, which can be formed on the durable layer or the release layer by evaporation method or sputtering method. Through the different refractive indexes in the compound-material layer, the light can not be reflected smoothly. Thus, the present invention produces a visible mat result (low glossy) on the surface of the decorative film and the decorative molding article equipped with the decorative film.

Furthermore, the present invention can partially forms the compound-material layer. It is performed by applying the shielding layer formed on the durable layer, forming the compound-material layer by evaporation method or sputtering method, and stripping the shielding layer. Thus, the compound-material layer has a partial pattern, and a visible result of glossy-bright-glossy is formed on its surface. Moreover, the present invention can omit the conventional ink layer according to the fifth embodiment, yet it has a luxurious metallic design similar to the color tone of a metal plating.

Moreover, through the metallic compound-material layer of the present invention, an ink layer which is usually used to show figure or texture can be omitted. Not only an effect of mat with a luxurious metallic design is provided, but also an ink layer with the manufacturing time can be omitted and save cost.

The above-mentioned descriptions represent merely the preferred embodiment of the present invention, without any intention to limit the scope of the present invention thereto. Various equivalent changes, alternations or modifications based on the claims of present invention are all consequently viewed as being embraced by the scope of the present invention.

What is claimed is:

1. A decorative film, comprising:
a carrier layer;
a release layer, formed on the carrier layer;
a compound-material layer, being contiguous to the release layer, and compounded of at least two materials with different refractive index;
thereby after the release layer is released, a gloss on the surface of the decorative film is reduced by the compound-material layer.

2. The decorative film according to claim 1, further comprising a patterned ink layer formed on the compound-material layer.

3. The decorative film according to claim 2, further comprising an adhesive layer formed on the patterned ink layer.

4. The decorative film according to claim 1, further comprising a durable layer formed on one side of the compound-material layer.

5. The decorative film according to claim 4, wherein the compound-material layer is formed fully on the durable layer.

6. The decorative film according to claim 4, wherein the compound-material layer is covered partially on the durable layer.

7. The decorative film according to claim 1, wherein the compound-material layer is formed by evaporation method or sputtering method.

8. A method for manufacturing a decorative film, comprising:
providing a carrier layer;
forming a release layer on the carrier layer; and
depositing a compound-material layer contiguous to the release layer, wherein the compound-material layer is compounded of at least two materials with different refractive index;
thereby after the release layer is released, a gloss on the surface of the decorative film is reduced by the compound-material layer.

9. The method for manufacturing a decorative film according to claim 8, further comprising: patterning the compound-material layer.

10. The method for manufacturing a decorative film according to claim 9, wherein the step of patterning the compound-material layer comprising:
forming a durable layer on one side of the compound-material layer;
forming a shielding layer on a part of the durable layer; and
depositing the compound-material layer and the compound-material layer is patterned.

11. The method for manufacturing a decorative film according to claim 10, further comprising the steps of:
stripping the shielding layer to form a plurality of trenches, the trenches are exposed a portion of the durable layer and side walls of the compound-material layer; and
printing an ink layer on the trenches;
thereby forming a visible result of glossy-bright-glossy on the surface of the durable layer.

12. The method for manufacturing a decorative film according to claim 10, further comprising the steps of:
stripping the shielding layer to form a plurality of trenches, the trenches are exposed a portion of the durable layer and side walls of the compound-material layer; and
forming an adhesive layer on the trenches and the compound-material layer.

13. The method for manufacturing a decorative film according to claim 10, wherein the compound-material layer comprises at least one metal nitride layer.

14. The method for manufacturing a decorative film according to claim 10, wherein the compound-material layer comprises at least one metal layer.

15. A decorative molding article, comprising:
the decorative film according to claim 1; and
a plastic piece formed on the compound-material decorative layer.

16. The decorative molding article according to claim 15, wherein the plastic piece is formed on the decorative film by injection molding method, thermoforming molding method, compression molding method, blow molding method, heat transfer method, hot stamping method, laminating method, in-mold method, or extrusion molding method, or an assembled method thereof.

17. The decorative molding article according to claim 15, wherein the plastic piece is selected from the group consisting of Polycarbonate (PC), polypropylene (PP), Polymethyl methacrylate (PMMA), Styrene-methyl methacrylate copolymer (MS), Acrylonitrile butadiene styrene (ABS), Polystyrene (PS), Polyethylene terephthalate (PET), Polyoxymethylene (POM) and Nylon.

18. The decorative molding article according to claim 15, wherein the decorative molding component is shaped in a shell for a mobile phone, digital camera, personal digital assistant (PDA), notebook PC, desktop PC, touch panel, television, GPS (globe position system) device, car monitor, navigation display, digital photo frame, DVD player, cosmetics products, toys, car dashboard, clock, radio, watch, credit card or smart card.
